(19) United States
(12) Patent Application Publication
(10) Pub. No.: US 2026/0119306 A1
(43) Pub. Date: Apr. 30, 2026

(54) METHOD FOR HANDLING MALFUNCTIONS, ELECTRONIC DEVICE, AND STORAGE MEDIUM

(71) Applicant: Fulian Precision Electronics (Tianjin) Co., LTD., Tianjin (CN)

(72) Inventors: HSIAO-WEN TSAI, New Taipei (TW); SHENG-CHUNG PAN, New Taipei (TW)

(21) Appl. No.: 18/969,518

(22) Filed: Dec. 5, 2024

(30) Foreign Application Priority Data
Oct. 31, 2024 (CN) 202411544633.9

(51) Int. Cl. G06F 11/07

(52) U.S. Cl. CPC G06F 11/0793; G06F 11/0727; G06F 11/079

(57) ABSTRACT

A method for handling malfunctions is provided. In the method, in response that a working temperature of a first device is abnormal, an electronic device collects a running log of the first device. Log data that matches the running log is obtained from a database. A second device is determined according to a position where the first device is located. The electronic device detects whether a second device has an abnormal trend on working temperatures, and a detection result is obtained. A plurality of handling strategies of the first device and/or the second device are determined, according to the detection result and the log data. The above method can monitor the working temperature of a device in a timely and effective manner, thereby ensuring stable operation and performance of the device.

### FIELD

The present disclosure relates to a field of monitoring, and more particularly to a method for handling malfunctions, an electronic device, and a storage medium.

### BACKGROUND

With the rapid development of cloud computing, big data, artificial intelligence and other technologies, data scale and energy demand of data centers have increased dramatically. With an expansion of the data scale, volume of data in the data centers has also exploded. If a data monitoring system has limited data processing capabilities, it cannot monitor other electronic devices in a timely and effective manner, thus affecting using of the electronic devices.

### BRIEF DESCRIPTION OF THE DRAWINGS

In order to more clearly illustrate technical solutions in the embodiments of the present disclosure, drawings that need to be used in the descriptions of the embodiments or the prior art will be briefly introduced below. Obviously, the drawings in the following description are merely some examples of the present disclosure, those of ordinary skill in the art can also obtain other drawings based on the drawings without paying creative efforts.

FIG. 1 is a structural diagram of an electronic device in an embodiment of the present disclosure.

FIG. 2 is a flowchart of a method for handling malfunctions in an embodiment of the present disclosure.

FIG. 3 is a flowchart of a method for handling malfunctions in another embodiment of the present disclosure.

FIG. 4 is a flowchart of a method for handling malfunctions in yet another embodiment of the present disclosure.

FIG. 5 is a structural diagram of a handling device in an embodiment of the present disclosure.

### DETAILED DESCRIPTION

The technical solutions in the embodiments of the present disclosure will be clearly and completely described below in conjunction with the drawings in the embodiments of the present disclosure, and it is obvious that a described embodiment is a part of the embodiments of the present disclosure, not all of the embodiments. Based on the embodiments in the present disclosure, all other embodiments obtained by a person of ordinary skill in the art without creative labor fall within the scope of protection of the present disclosure.

Hereinafter, terms “first” and “second” are used for descriptive purposes only, and are not to be construed as indicating or implying relative importance or implicitly specifying the number of technical features indicated. Thus, a feature defined with “first” or “second” may include one or more such features, either explicitly or implicitly. In the description of the embodiments of the present disclosure, words “exemplary” or “for example” are used to indicate an example, an illustration, or an illustration. Any embodiment or design solution described as “exemplary” or “for example” in the embodiments of the present disclosure should not be construed as being preferred or advantageous over other embodiments or design solutions. Rather, the words “exemplary” or “for example” is intended to present the relevant concepts in a specific manner.

Unless otherwise defined, all technical and scientific terms used herein have the same meaning as commonly understood by those skilled in the art in which this disclosure is filed. The terms used in the specification of this disclosure are used only for the purpose of describing specific embodiments and are not intended to limit this disclosure. It should be understood that in this disclosure, unless otherwise indicated, “/” means or. For example, A/B may denote either A or B. “And/or” in this disclosure is merely an associative relationship describing an associated object, indicating that three relationships may exist. For example, A and/or B can mean: A alone, both A and B, and B alone. “At least one” means one or more. “More than one” means two or more than two. For example, at least one of “a”, “b” or “c” can mean: “a”, “b”, “c”, “a” and “b”, “a” and “c”, b and “c”, “a”, “b” and “c” in seven cases.

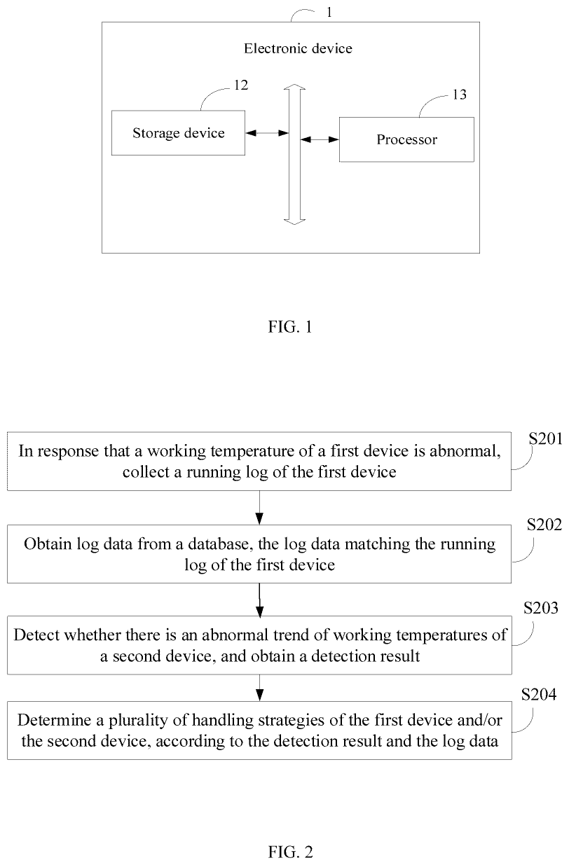

FIG. 1 is a structural diagram of an electronic device in an embodiment of the present disclosure.

In some embodiments of the present disclosure, a method for handling malfunctions can be applied to one or more electronic devices 1, and the electronic device 1 is a device capable of executing computer-readable instructions to automatically perform numerical calculations and/or information processing, and its hardware includes but is not limited to a microprocessor, an Application Specific Integrated Circuit (ASIC), a Field [symbol] Programmable Gate Array (FPGA), a Digital Signal Processor (DSP), embedded devices and so on.

The electronic device 1 may be any kind of electronic product that allows human-computer interactions with a user, such as, for example, a personal computer, a tablet computer, a smartphone, a Personal Digital Assistant (PDA), a gaming console, an Internet Protocol Television (IPTV), smart wearable devices, and the like.

The electronic device 1 may include a network device and/or a user device. The network device includes but is not limited to a single network electronic device, a group of electronic devices including a plurality of network electronic devices, or a cloud server including a large number of hosts or network electronic devices based on cloud computing.

A network that the electronic device 1 is connected includes but is not limited to the Internet, a wide area network, a metropolitan area network, a local area network, a Virtual Private Network (VPN), and the like.

In some embodiments of the present disclosure, the electronic device 1 includes, but is not limited to a storage device 12, a processor 13, and computer-readable instructions, such as handling malfunctions programs, stored in the storage device 12 and can be invoked by the processor 13.

It will be understood by those skilled in the art that the schematic drawings are merely examples of the electronic device 1 and do not constitute a limitation of the electronic device 1, and may include more or fewer components than illustrated, or a combination of certain components, or different components, e.g., the electronic device 1 may also include an input/output device, a network access device, a bus, and the like.

The processor 13 may be a central processing unit (CPU), or may be other general-purpose processor, a digital signal processor (DSP), an Application Specific Integrated Circuit (ASIC), Field-Programmable Gate Array (FPGA) or other programmable logic devices, discrete gate or transistor logic devices, discrete hardware components, and so on. The general-purpose processor can be a microprocessor or processor can be any conventional processor, etc., the processor 13 is the computing core and control center of the electronic device 1, using a variety of interfaces and lines to connect various parts of the entire electronic device 1, and the execution of the operating system of the electronic device 1, as well as the installation of various types of application programs, program code, etc.

The storage device 12 may be an external memory and/or an internal memory of the electronic device 1. Further, the storage device 12 may be a memory having a physical form, such as a memory stick, a Trans-flash Card, and the like.

In relation with FIG. 2 to FIG. 4, the storage device 12 in the electronic device 1 stores computer-readable instructions, and the processor 13 may execute the computer-readable instructions stored in the storage device 12 thereby realizing a plurality of processes as shown in FIG. 2-FIG. 4 to implement the method for handling malfunctions.

FIG. 2 is a flowchart of a method for handling malfunctions in an embodiment of the present disclosure. The method for handling malfunctions is applied to an electronic device, such as the electronic device 1 in FIG. 1. The electronic device may be a first device or a second device. As shown in FIG. 2, the method for handling malfunctions in the embodiments of the present disclosure comprises steps S201-S204. According to different needs, an order of the following blocks in the flowchart can be changed, and some of them can be omitted.

In block S201, in response that a working temperature of a first device is abnormal, the electronic device collects a running log of the first device.

In one embodiment, the first device may be a large data center, or a medium data center, or a small data center. The first device may be connected to sensors, and the sensors may also be installed in the first device. The sensors may include, but are not limited to, a temperature sensor, an acceleration sensor, a barometric pressure sensor, a position sensor. The working temperature of the first device may be obtained from a temperature sensor of the first device, and the working temperature of the first device may also be obtained from a temperature sensor connected to the first device. The working temperature of the first device may include but is not limited to a working temperature of a host computer in the first device, a working temperature of an uninterruptible power supply (UPS) in the first device, and a working temperature of a power distribution unit (PDU) in the first device. The embodiments can monitor the working temperature of the first device in real time by the temperature sensor, and temperature condition of the first device can be quickly accessed.

In one embodiment, the running log may include, but is not limited to, a system log of WINDOWS™ operating system, a system log of LINUX™ operating system.

In one embodiment, the electronic device may provide a display interface, and the electronic device displays device information of the first device and/or a second device in a preset form on the display interface. The device information includes, but is not limited to the working temperature, location information, and an operating state, the location information may be determined from a location sensor, and the operating state may be determined based on performances of the device; the preset form may include, but is not limited to a list view, and a plan layout diagram. By converting the device information into a preset form for display, the temperature condition, the location information, and the operating state of the first device or the second device can be intuitively understood by a user.

In one embodiment, the electronic device determines a tool according to a plurality of preset monitoring objects of the first device. The preset monitoring objects may include systems and applications to be monitored, events to be monitored, etc., and the preset monitoring objects may be set according to user requirements. The tool may include, but is not limited to, an event viewer of the WINDOWS™ operating system, a syslog of the LINUX™ operating system, and a third-party log management tool (for example, Splunk, ELK Stack, Gray log). The electronic device can be used to configure collection rules of the tool, in which the collection rules can include, but are not limited to log sources, log levels, filter conditions, storage locations and a format of logs. The electronic device collects the running log of the first device according to the collection rules configured in the tool.

A suitable tool can be determined according to the preset monitoring objects, which can reduce data loss or error due to the tool. By configuring the collection rules in the tool, the collection of unnecessary data can be reduced and the efficiency of log collection can be improved.

In one embodiment, in response that the working temperature of the first device is abnormal, the electronic device sends alert information to a terminal device. The terminal device may be an electronic device designated by a preset person. The alert information may include, but is not limited to, location information of the first device, the working temperature of the first device, causes of temperature abnormality of the first device, and a description of the temperature abnormality of the first device.

In response that the working temperature of the first device is abnormal, the electronic device sends the alert information, thus, a user of the terminal device can realize the temperature abnormality of the first device in a timely manner, thereby ensuring stable operation of the device.

In block S202, the electronic device obtains log data from a database. The log data matches the running log.

In one embodiment, the electronic device extracts keywords of the running log based on a plurality of preset rules. The electronic device determines the log data, according to a preset log in the database, and the preset log includes the keywords.

The plurality of preset rules may be set to as follows: rules for determining keywords. For example, in response to any words having a number of appearances in the running log more than or equal to a threshold value, the any words can be used as keywords. For example, the running log of the first device can be represented as:“{log title: temperature abnormality warning of CPU in the server}, {log description: high temperature abnormality of the CPU in a server “S1”, a current temperature is 85° C. (a safety threshold is 75° C.), this situation has been going on for 5 minutes since 13:55:00 at a high temperature of 85° C., and a temperature sensor “TEMP_S1_CPU” continues to report a high temperature condition and a CPU utilization remains within a normal range (45%)}”. The electronic device extracts the keywords of the running log based on the plurality of preset rules. For example, the threshold value is set to be “2”, it is indicated that the information is used as the keywords for more than two times in the running log. For another example, a number of “CPU” appeared in the running log is three times, a number of “high temperature” appeared in the running log is two times, and a number of “85° C.” appeared in the running log is two times. Therefore, the keywords in the running log include “CPU”, “high temperature”, and “85° C.”. The log data can be a preset log in the database that includes the keywords.

Keywords related to specified events to be extracted from the running log according to the preset rules, so that important information can be quickly found and a time for processing irrelevant information can be reduced. By searching the preset logs in the database through the keywords, a log matching the running log can be found quickly among a large number of the preset logs, a searching efficiency can be improved.

In one embodiment, the electronic device traverses the preset logs in the database according to a structured query language or other database query language. The electronic device counts a number of keywords of the preset logs, and using a preset log with the largest number of keywords as the log data. For example, three logs are traversed through using the structured query language, three logs are represented as follows: {a first log: “CPU temperature reaches high temperature alert, and a current temperature has reached 85° C. Please take measures to cool down immediately”; a second log: “a system has detected high temperature, and a current temperature is 82° C. Please check the cooling system”; a three log: “CPU performance is seriously affected under high temperature environment, and a current temperature is 78° C. It is recommended to optimize the heat dissipation environment”}. The first log includes “CPU”, “high temperature”, “85° C.”, and the first log has three keywords. The second log includes “CPU”, and the second log has one keyword. The third log includes “CPU”, “high temperature”, and the third log has two keywords. The electronic device determines the first log that has the largest number of keywords as the log data. As another example, three logs are traversed through using the structured query language, three logs are represented as follows: {a fourth log: “a faulty fan causes temperature of the CPU to rise abnormally, and a current temperature is 85° C. Please replace the fan immediately”; a fifth log: “temperature of the CPU has been reduced from an original high temperature of 90° C. to a current 80° C. But it is still necessary to continue to monitor to prevent temperature rising again”; a sixth log: “CPU temperature reaches high temperature alert, a current temperature of CPU has reached 85° C., and system performance may be affected”}. The fourth log includes a keyword “CPU” and a keyword “85° C.”, the fourth log has two keywords. The fifth log includes a keyword “CPU” and a keyword “high temperature”, the fifth log has two keywords. The sixth log includes two keywords “CPU” and a keyword “85° C.”, the sixth log has three keywords. The electronic device determines the sixth log that has the largest number of keywords as the log data.

According to structured query language or other database query language, different matching rules of keywords can be adapted, and flexibility of querying can be improved. Accuracy and comprehensiveness can be improved by counting the numbers of the keywords included in the preset logs and then determining the log data based on the numbers of the keywords.

In block S203, the electronic device detects whether there is an abnormal trend of working temperatures of a second device, and obtains a detection result.

In one embodiment, the second device is selected according to a position of the second device relative to a position of the first device. The detection result may include a first result and a second result, the first result can indicate that there is the abnormal trend of the working temperatures of the second device, and the second result can indicate that there is no abnormal trend of the working temperatures of the second device.

In one embodiment, the electronic device collects working temperatures of the second device in a first time period, and collects working temperatures in a second time period. The first time period is chronologically before the second time period. The electronic device obtains time series data, based on the working temperatures of the first time period and the working temperatures of the second time period. The electronic device divides the time series data into a plurality of time windows, and calculates an average temperature of each of the plurality of time windows. The plurality of time windows may have a same length of time. The electronic device determines whether there is any abnormal trend of working temperatures of the second device, and obtains the detection result based on the calculated average temperature of each of the plurality of time windows.

By constructing the working temperatures of the second device as ordered time series data, the efficiency of data analysis can be improved. By dividing the time series data into the time windows having the same length and calculating the average temperature for each time window, an impact on the overall temperature trend determination due to instantaneous temperature fluctuations can be reduced because a calculation is not performed on the time series data, thereby improving an accuracy and reliability of the detection result.

In one embodiment, the electronic device determines the working temperatures of the second device in the first time period as the first temperature, and determines the working temperatures in the second time period as the second temperature. The electronic device establishes a correspondence relation between each timestamp in the first time period and the first temperature, establishes a correspondence relation between each timestamp in the second time period and the second temperature, and obtains key-value pairs (e.g., timestamp-temperature). The electronic device arranges the key-value pairs in a chronological order, and the electronic device obtains the time series data. The timestamp is used to indicate time that acquires each working temperature.

By matching the working temperatures with corresponding timestamps, and a clear correspondence relation can be established, an analysis based on the data can be easier. By arranging the key-value pairs in the chronological order, an orderly data structure can be formed, thereby improving the efficiency of analysis.

In one embodiment, the electronic device determines a start time and an end time of the time series data. The electronic device starts from the start time, and divides the time series data into the plurality of time windows having the same length. The electronic device calculates the average temperature of the working temperatures within each time window.

For example, the working temperatures are recorded at five minute intervals, the time series data of the first device is acquired from 12:00 to 13:00, the time series data include (22° C., 23° C., 24° C., 25° C., 26° C., 25° C., 27° C., 28° C., 27° C., 26° C., 25° C., 24° C.), a length of the time window is set to be fifteen minutes, the electronic device divides the time series data into four time windows having the same length. For example, a first window is (22° C., 23° C., 24° C.), a second window is (25° C., 26° C., 25° C.), a third window is (27° C., 28° C., 27° C.), and a fourth window is (26° C., 25° C., 24° C.), and a corresponding average temperature of the first window is calculated as: (22+23+24)/3=23(° C.); a corresponding average temperature of the second window is calculated as: (25+26+25)/3=25.33 (° C.); a corresponding average temperature of the third window is calculated as: (27+28+27)/3=27.33 (° C.); a corresponding average temperature of the fourth window is calculated as: (26+25+24)/3=25 (° C.). The electronic device determines temperature averages are (23° C., 25° C., 27° C., 25° C.).

By determining the start time and the end time of the time series data, a range of data to be analyzed can be determined, and an accuracy and completeness of the working temperatures can be ensured. By dividing the time series data into the plurality of time windows, an analysis process of the data can be simplified, to make the data be easier to process. By calculating all the working temperatures in each time window, working temperatures can be avoided missing, and an accuracy of the average temperature can be improved.

In one embodiment, the electronic device measures a time distance of every two time windows, determines a shortest time distance from the time distances measured and determines one or more time window groups from the plurality of time windows corresponding to the shortest time distance. The electronic device calculates a mean difference of each of the one or more time window groups, according to an average temperature of each time window of each of the one or more time window groups. The electronic device determines the detection result is the first result, in response that no mean differences is within a second preset range.

By determining a time distance between every two time windows, an interval between the time windows can be quantified, to enable an identification of the time window groups. Accuracy of the detection result can be improved by comparing the average temperature of two neighboring time windows.

In one embodiment, the electronic device determines a start time of each time window, and calculates a time distance of every two time windows based on the start time of each time window. The electronic device determines the shortest time distance and determines the time window groups corresponding to the shortest time distance. The time distance may also be determined based on the end time of each time window.

Based on the above examples, the time series data includes working temperatures from 12:00 to 13:00, and the time series data may be divided into four time windows having the same length: the first window “12:00:00-12:15:00”; the second window “12:15:00-12:30:00”; the third window “12:30:00-12:45:00”; the fourth window “13:45:00-14:00:00”. A start time of the first window is: 12:00:00; a start time of the second window is: 12:15:00; a start time of the third window is: 12:30:00; a start time of the fourth window is: 12:45:00. After calculating, a time distance between the first window and the second window is fifteen minutes, a time distance between the second window and the third window is fifteen minutes; a time distance between the third window and the fourth window is fifteen minutes; a time distance between the first window and the third window is thirty minutes; a time distance between the first window and the fourth window is forty five minutes; and a time distance between the second window and the fourth window is thirty minutes. The time windows corresponding to the shortest time distance are determined as time window groups, and since the shortest time distance of the time windows include the first window with the second window, the second window with the third window, and the third window with the fourth window, the time window groups include: the first window with the second window, the second window with the third window, and the third window with the fourth window.

By determining a start time or an end time of each time window, a range of every two time windows can be defined clearly, thereby ensuring an accuracy and a consistency of the time distance and improving the accuracy of the time window group.

In one embodiment, the electronic device calculates the mean difference of each of the one or more time window groups, according to the average temperature of each time window of each of the one or more time window groups. In response that no mean differences are in a second preset range, the electronic device determines the detection result is the first result. The second preset range may be set and adjusted according to actual requirements. Base on above example, the time series data includes four time windows, the average temperatures of the four time windows are represented as (23° C., 25° C., 27° C., 25° C.), a mean difference between the average temperature of the first window and the second window is 2° C., a mean difference between the average temperature of the second window and the third window is 2° C., a mean difference between the average temperature of the third window and the fourth window is 2° C. In response that the second preset range is set to (−1° C., 1° C.), the electronic device determines the detection result is the first result because the mean difference between the average temperature of the first window and the second window, the mean difference between the average temperature of the second window and the third window, and mean difference between the average temperature of the third window and the fourth window are not within a range of (−1° C., 1° C.).

The detection result is determined by comparing the mean difference of the time window groups with the second preset range, and a detection efficiency can be improved as there is no need to analyze the mean difference of the time series data.

In one embodiment, in response that all mean differences are within the second preset range, the electronic device determines the detection result is the second result.

In block S204, the electronic device determines a plurality of handling strategies of the first device and/or the second device, according to the detection result and the log data.

In one embodiment, in response that the detection result is the first result, the electronic device determines handling strategies corresponding to the first device from the database according to the log data, and determines handling strategies corresponding to the second device from the database according to an abnormal log of the second device. In response that the detection result is the second result, the electronic device determines handling strategies corresponding to the first device from the database according to the log data.

In one embodiment, the first result indicates that the working temperatures of the second device are affected by the working temperature of the first device. The electronic device determines the plurality of handling strategies corresponding to the log data in the database. While solving the malfunctions of the first device with the plurality of handling strategies of the first device, the malfunctions of the second device can also be solved. The plurality of handling strategies is pre-stored in the database.

In response that the working temperatures of the second device are affected by the working temperature of the first device, the plurality of handling strategies are acquired through the log data of the first device. The handling strategies can be used to solve malfunctions of the first device and the second device at the same time, so as to reduce time of handling malfunctions and improve an efficiency of handling malfunctions.

In one embodiment, the electronic device collects an abnormality log of the second device, and obtains the plurality of handling strategies of the second device by matching the abnormality log with a preset log in the database. By collecting the abnormality log of the second device, fault problems of the second device can be determined, thereby comprehensively monitoring health status of the second device.

In one embodiment, the second result indicates that the working temperatures of the second device are affected by the working temperature of the first device. The electronic device determines strategies corresponding to the log data in the database as the plurality of handling strategies of the first device. The plurality of handling strategies of the first device may resolve an abnormal problem that occurs in the first device.

By collecting the running log of the first device, a data base for subsequent analysis can be provided. By acquiring log data that matches the running log, from the database, the log data that has similar problems with the running log of the first device can be identified. Thus, a root cause of the malfunctions in the first device can be located quickly. By detecting whether there is any abnormal trend of working temperatures of the second device, the abnormal trend of the second device can be detected in time. Based on the detection result and the log data, the plurality of handling strategies of the first device and/or the second device are determined, and an effective handling strategies can be obtained, thereby ensuring stable operation and performance of the device and improving a user experience.

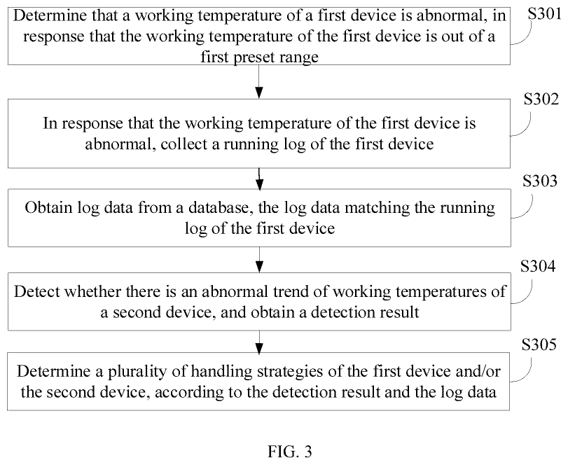

FIG. 3 is a flowchart of a method for handling malfunctions in another embodiment of the present disclosure. The method for handling malfunctions is applied to an electronic device, such as the electronic device 1 in FIG. 1. The electronic device may be a first device or a second device. As shown in FIG. 3, the method for handling malfunctions in the embodiments of the present disclosure includes steps S301-S305. According to different needs, an order of the following blocks in the flowchart can be changed, and some of them can be omitted.

In block S301, in response that a working temperature of a first device is out of a first preset range, the electronic device determines that the working temperature of the first device is abnormal.

In one embodiment, the first preset range may include a first threshold value and a second threshold value, and the first threshold value is less than the second threshold value. The first preset range may be set and adjusted according to actual requirements. In response that the working temperature of the first device is less than or equal to the first threshold value, the working temperature of the first device is determined to be too low, and the electronic device determines that the working temperature of the first device is abnormal. In response that the working temperature of the first device is greater than or equal to the second threshold value, the working temperature of the first device is determined to be too high, and the electronic device determines that the working temperature of the first device is abnormal. For example, the first threshold value is set to 20° C., the second threshold value is set to 32° C., and the first preset range is determined to be (20° C., 32° C.). The working temperature of the first device is monitored to be 35° C., as 35° C. is greater than the second threshold value of 32° C., the working temperature of the first device is out of the first preset range (20° C., 32° C.), the electronic device determines that the working temperature of the first device is abnormal. The working temperature of the first device is monitored to be 15° C., as 15° C. is less than the first threshold value of 20° C., the working temperature of the first device is out of the first preset range (20° C., 32° C.), the electronic device determines that the working temperature of the first device is abnormal.

In one embodiment, in response that the working temperature of the first device is in the first preset range, the electronic device monitors the working temperature of the first device continuously. By setting the first preset range, a working temperature condition of the first device can be determined. The first preset range can provide a normal range for the working temperature of the first device, and an accuracy and reasonableness of determination can be ensured.

In block S302, in response that the working temperature of the first device is abnormal, the electronic device collects a running log of the first device.

In block S303, the electronic device obtains log data from a database, the log data matches the running log.

In block S304, the electronic device detects whether there is any abnormal trend of working temperatures of a second device, and obtains a detection result.

In block S305, the electronic device determines a plurality of handling strategies of the first device and/or the second device, according to the detection result and the log data.

Blocks S302-S305 can be referred to detailed descriptions of blocks S201-S204 in FIG. 2, and the descriptions are not repeated here.

According to the first preset range, automation and intelligent management of the devices can be realized. In response that the working temperature of the first device is out of the first preset range, the first device may invoke the method for handling malfunctions, to avoid handling malfunctions due to minor fluctuations or interference. Thus, the accuracy of handling malfunctions can be ensured.

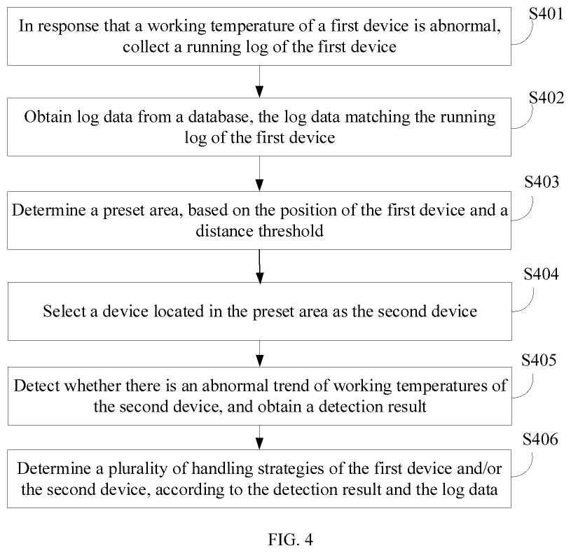

FIG. 4 is a flowchart of a method for handling malfunctions in another embodiment of the present disclosure. The method for handling malfunctions is applied to an electronic device, such as the electronic device 1 in FIG. 1. The electronic device may be a first device or a second device. As shown in FIG. 4, the method for handling malfunctions in the embodiments of the present disclosure comprises steps S401-S406. According to different requirements, an order of the following blocks in the flowchart can be changed, and some of them can be omitted.

In block S401, in response that a working temperature of a first device is abnormal, the electronic device collects a running log of the first device.

In block S402, the electronic device obtains log data from a database, the log data matches the running log.

Blocks S401-S402 can be referred to detailed descriptions of blocks S201-S202 in FIG. 2, and the descriptions are not repeated here.

In block S403, the electronic device determines a preset area, based on the position of the first device and a distance threshold.

In one embodiment, the electronic device configures a label for the first device, and associates the label corresponding to location information of the first device. In response that the working temperature of the first device is out of a first preset range, the electronic device determines the location information corresponding to the first device based on the label of the first device. The label corresponding to the first device may be an identifier (ID), a serial number, and the like. The location information may include latitude and longitude, floor, room number, and the like.

By associating the label with the location information of the first device, the location information of the device in relation with the label can be determined, so that a malfunctioning device can be quickly localized.

In one embodiment, the electronic device determines the location information of the first device as a center, and the electronic device determines a preset region according to the center and a distance threshold. The distance threshold may be set and adjusted according to actual requirements. A shape of the preset region may be a circle, a rectangle, a polygon, and the like. For example, the preset region may be a circle with the position information of the first device as the center and the distance threshold as the radius. The preset region may be a rectangular region, whose center is the first device and side length are the distance threshold, according to the position information of the first device.

By setting the distance threshold according to actual requirements, different shapes of the preset region can be determined, requirements of different scenarios can be met, and reasonableness of the determination of the second device can be improved.

In block S404, the electronic device selects a device located in the preset area as the second device.

In one embodiment, the electronic device determines whether a device position is within the preset region, based on the device position of a preset device. The preset device located within the preset region is determined to be the second device.

In block S405, the electronic device detects whether there is any abnormal trend of working temperatures of a second device, and obtains a detection result.

In block S406, the electronic device determines a plurality of handling strategies of the first device and/or the second device, according to the detection result and the log data.

Blocks S405-S406 can be referred to detailed descriptions of blocks S203-S204 in FIG. 2, and the descriptions are not be repeated here.

By determining a preset region based on the position information of the first device and the distance threshold, a selection range can be reduced and the efficiency of determining the second device can be improved.

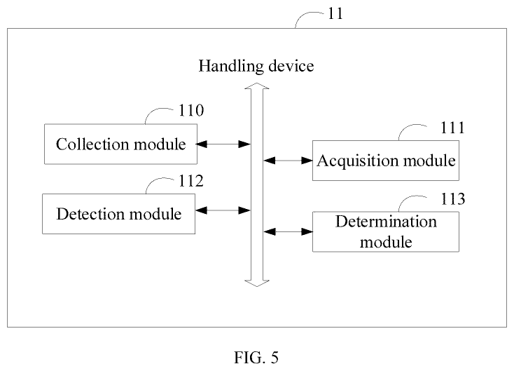

FIG. 5 is a structural diagram of a handling device in an embodiment of the present disclosure. In some embodiments, the handling device 11 may include a collection module 110, an acquisition module 111, a detection module 112, and a determination module 113. The modules in this disclosure refers to a series of computer-readable instruction segments capable of being acquired by a processor (e.g., the processor 13 shown in FIG. 1) and capable of accomplishing a fixed function, which are stored in a storage device (e.g., the storage device 12 shown in FIG. 1).

The collection module 110 collects a running log of a first device, in response that a working temperature of the first device is abnormal. The acquisition module 111 obtains log data from a database, the log data matches the running log of the first device. The detection module 112 detects whether there is an abnormal trend of working temperatures of a second device, and obtains a detection result, the second device is selected according to a position of the second device relative to a position of the first device. The determination module 113 determines a plurality of handling strategies of the first device and/or the second device, according to the detection result and the log data.

The acquisition module 111 extracts keywords of the running log based on a plurality of preset rules, and determines the log data, according to a preset log in the database, the preset log including the keywords.

In response that the working temperature of the first device is out of a first preset range, the determination module 113 determines that the working temperature of the first device is abnormal.

The determination module 113 determines a preset area, based on the position of the first device and a distance threshold, and selects a device located in the preset area as the second device.

The detection module 112 collects working temperatures of the second device in a first time period and working temperatures in a second time period, the first time period is chronologically before the second time period. The detection module 112 obtains time series data, based on the working temperatures of the first time period and the working temperatures of the second time period. The detection module 112 divides the time series data into a plurality of time windows, and calculates an average temperature of each of the plurality of time windows, the plurality of time windows having a same length of time. The detection module 112 determines whether there is the abnormal trend of working temperatures of the second device, and obtains the detection result based on the calculated average temperature of each of the plurality of time windows.

The detection module 112 measures a time distance of every two time windows, determines a shortest time distance from the time distances measured and determines one or more time window groups from the plurality of time windows corresponding to the shortest time distance. The detection module 112 calculates a mean difference of each of the one or more time window groups, according to an average temperature of each time window of each of the one or more time window groups. The detection module 112 determines the detection result is a first result, in response that no mean differences is in a second preset range, the first result indicating that there is the abnormal trend of the working temperatures of the second device.

The detection module 112 determines the detection result is a second result, in response that all mean differences are within the second preset range, the second result indicating that there is no abnormal trend of the working temperatures of the second device.

In response that the detection result is a first result, the determination module 113 determines handling strategies corresponding to the first device from the database according to the log data, and determines handling strategies corresponding to the second device from the database according to an abnormal log of the second device. In response that the detection result is a second result, the determination module 113 determines handling strategies corresponding to the first device from the database according to the log data.

By collecting the running log of the first device, a data base for subsequent analysis can be provided. By acquiring log data that matches the running log, from the database, the log data that has similar problems with the running log of the first device can be identified. Thus, a root cause of the malfunctions in the first device can be located quickly. By detecting whether there is any abnormal trend of working temperatures of the second device, the abnormal trend of the second device can be detected in time. Based on the detection result and the log data, the plurality of handling strategies of the first device and/or the second device are determined, and an effective handling strategies can be obtained, thereby ensuring stable operation and performance of the device and improving a user experience.

The modules/units integrated in the electronic device 1 may be stored in a computer-readable storage medium if implemented as software functional units and sold or used as stand-alone products. Based on this understanding, all or part of the processes in the method of above-described embodiments may also be realized by the present disclosure through computer-readable instructions to instruct the relevant hardware to complete, and the computer-readable instructions may be stored in a computer-readable storage medium, which computer-readable instructions, when executed by a processor, may realize the blocks of above-described method embodiments.

The computer-readable instructions include computer-readable instruction code, the computer-readable instruction code may be in the form of a source code, in the form of an object code, in the form of an executable file, or in some intermediate form, and the like. The computer-readable medium may include any entity or device capable of carrying the computer-readable instruction code, a recording medium, a USB flash drive, a removable hard disk, a diskette, a CD-ROM, a computer memory, a Read-Only Memory (ROM).

Specifically, the specific implementation method of the processor 13 for the above-described computer-readable instructions can be referred to the description of the relevant blocks in the corresponding embodiments of FIG. 2-FIG. 4, and will not be repeated herein.

In the several embodiments provided in the preset disclosure, the disclosed device and method can be implemented in other ways. For example, the embodiments of the devices described above are merely illustrative. For example, a division of the modules is based on logical function only, and there can be other manners of division in actual implementation.

The modules illustrated as separated components may or may not be physically separated, and the components displayed as modules may or may not be physical units, for example, the modules may be located in one place, or the modules may be distributed to a plurality of network units. Some or all of these modules may be selected to fulfill the purpose of the embodiment scheme according to actual needs.

In addition, each functional module in each embodiment of the present disclosure can be integrated into one processing module, or can be physically present separately in each unit, or two or more modules can be integrated into one module. The above modules can be implemented in a form of hardware or in a form of a software functional unit.

Therefore, the present embodiments are considered as illustrative and not restrictive, and the scope of the present disclosure is defined by the appended claims. All changes and variations in the meaning and scope of equivalent elements are included in the present disclosure. Any reference sign in the claims should not be construed as limiting the claim.

Furthermore, it is clear that the word “comprising” does not exclude other units or steps and that the singular does not exclude the plural. A plurality of units or devices may also be realized by one unit or device through software or hardware. Words such as first, second, etc. are used to indicate names and do not indicate any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A method to handle malfunctions, the method comprising:
in response that a working temperature of a first device is abnormal, collecting a running log of the first device;
obtaining log data from a database, the log data matching the running log of the first device;
detecting whether there is an abnormal trend of working temperatures of a second device, and obtaining a detection result, wherein the second device is selected according to a position of the second device relative to a position of the first device; and
determining a plurality of handling strategies of the first device and/or the second device, according to the detection result and the log data.

2. The method of claim 1, wherein obtaining the log data from the database comprises:
extracting keywords of the running log based on a plurality of preset rules;
determining the log data, according to a preset log in the database, the preset log comprising the keywords.

3. The method of claim 1, further comprising:
determining that the working temperature of the first device is abnormal, in response that the working temperature of the first device is out of a first preset range.

4. The method of claim 1, further comprising:
determining a preset area, based on the position of the first device and a distance threshold;
selecting a device located in the preset area as the second device.

5. The method of claim 1, wherein detecting whether there is the abnormal trend of working temperatures of the second device, and obtaining the detection result comprises:
collecting working temperatures of the second device in a first time period and working temperatures in a second time period, the first time period is chronologically before the second time period;
obtaining time series data, based on the working temperatures of the first time period and the working temperatures of the second time period;
dividing the time series data into a plurality of time windows, and calculating an average temperature of each of the plurality of time windows, the plurality of time windows having a same length of time;
determining whether there is the abnormal trend of working temperatures of the second device, and obtaining the detection result based on the calculated average temperature of each of the plurality of time windows.

6. The method of claim 5, wherein determining whether there is the abnormal trend of working temperatures of the second device, and obtaining the detection result based on the average temperature of each of the plurality of time windows comprises:
measuring a time distance of every two time windows, determining a shortest time distance from the time distances measured and determining one or more time window groups from the plurality of time windows corresponding to the shortest time distance;
calculating a mean difference of each of the one or more time window groups, according to an average temperature of each time window of each of the one or more time window groups;
determining the detection result is a first result, in response that no mean differences is in a second preset range, the first result indicating that there is the abnormal trend of the working temperatures of the second device.

7. The method of claim 6, further comprising:
determining the detection result is a second result, in response that all mean differences are within the second preset range, the second result indicating that there is no abnormal trend of the working temperatures of the second device.

8. The method of claim 1, wherein determining the plurality of handling strategies of the first device and/or the second device, according to the detection result and the log data comprises:
in response that the detection result is a first result, determining handling strategies corresponding to the first device from the database according to the log data, and determining handling strategies corresponding to the second device from the database according to an abnormal log of the second device;
in response that the detection result is a second result, determining handling strategies corresponding to the first device from the database according to the log data.

9. An electronic device comprising:
a processor; and
a storage device storing a plurality of instructions, which when executed by the processor, cause the processor to:
in response that a working temperature of a first device is abnormal, collect a running log of the first device;
obtain log data from a database, the log data matching the running log of the first device;
detect whether there is an abnormal trend of working temperatures of a second device, and obtain a detection result, wherein the second device is selected according to a position of the second device relative to a position of the first device; and
determine a plurality of handling strategies of the first device and/or the second device, according to the detection result and the log data.

10. The electronic device of claim 9, wherein the processor is further caused to:
extract keywords of the running log based on a plurality of preset rules;
determine the log data, according to a preset log in the database, the preset log comprising the keywords.

11. The electronic device of claim 9, wherein the processor is further caused to:
determine that the working temperature of the first device is abnormal, in response that the working temperature of the first device is out of a first preset range.

12. The electronic device of claim 9, wherein the processor is further caused to:
determine a preset area, based on the position of the first device and a distance threshold;
select a device located in the preset area as the second device.

13. The electronic device of claim 9, wherein the processor is further caused to:
collect working temperatures of the second device in a first time period and working temperatures in a second time period, the first time period is chronologically before the second time period;
obtain time series data, based on the working temperatures of the first time period and the working temperatures of the second time period;
divide the time series data into a plurality of time windows, and calculate an average temperature of each of the plurality of time windows, the plurality of time windows having a same length of time;
determine whether there is the abnormal trend of working temperatures of the second device, and obtain the detection result based on the calculated average temperature of each of the plurality of time windows.

14. The electronic device of claim 13, wherein the processor is further caused to:
measure a time distance of every two time windows, determine a shortest time distance from the time distances measured and determine one or more time window groups from the plurality of time windows corresponding to the shortest time distance;
calculate a mean difference of each of the one or more time window groups, according to an average temperature of each time window of each of the one or more time window groups;
determine the detection result is a first result, in response that no mean differences is in a second preset range, the first result indicating that there is the abnormal trend of the working temperatures of the second device;
determine the detection result is a second result, in response that all mean differences are within the second preset range, the second result indicating that there is no abnormal trend of the working temperatures of the second device.

15. A non-transitory storage medium having stored thereon at least one computer-readable instructions, which when executed by a processor of an electronic device, causes the processor to perform a method for handling malfunctions, wherein the method comprises:
in response that a working temperature of a first device is abnormal, collecting a running log of the first device;
obtaining log data from a database, the log data matching the running log of the first device;
detecting whether there is an abnormal trend of working temperatures of a second device, and obtaining a detection result, wherein the second device is selected according to a position of the second device relative to a position of the first device; and
determining a plurality of handling strategies of the first device and/or the second device, according to the detection result and the log data.

16. The non-transitory storage medium of claim 15, wherein obtaining the log data from the database comprises:
extracting keywords of the running log based on a plurality of preset rules;
determining the log data, according to a preset log in the database, the preset log comprising the keywords.

17. The non-transitory storage medium of claim 15, wherein the method further comprises:
determining that the working temperature of the first device is abnormal, in response that the working temperature of the first device is out of a first preset range.

18. The non-transitory storage medium of claim 15, wherein the method further comprises:
determining a preset area, based on the position where the first device is located and a distance threshold;
determining a device located in the preset area as the second device.

19. The non-transitory storage medium of claim 15, wherein detecting whether there is the abnormal trend of working temperatures of the second device, and obtaining the detection result comprises:
collecting working temperatures of the second device in a first time period and working temperatures in a second time period, the first time period is chronologically before the second time period;
obtaining time series data, based on the working temperatures of the first time period and the working temperatures of the second time period;
dividing the time series data into a plurality of time windows, and calculating an average temperature of each of the plurality of time windows, the plurality of time windows having a same length of time;
determining whether there is the abnormal trend of working temperatures of the second device, and obtaining the detection result based on the calculated average temperature of each of the plurality of time windows.

20. The non-transitory storage medium of claim 19, wherein determining whether there is the abnormal trend of working temperatures of the second device, and obtaining the detection result based on the average temperature of each of the plurality of time windows comprises:
measuring a time distance of every two time windows, determining a shortest time distance from the time distances measured and determining one or more time window groups from the plurality of time windows corresponding to the shortest time distance;
calculating a mean difference of each of the one or more time window groups, according to an average temperature of each time window of each of the one or more time window groups;
determining the detection result is a first result, in response that no mean differences is in a second preset range, the first result indicating that there is the abnormal trend of the working temperatures of the second device;
determining the detection result is a second result, in response that all mean differences are within the second preset range, the second result indicating that there is no abnormal trend of the working temperatures of the second device.
